(19) United States
(12) Patent Application Publication
(10) Pub. No.: US 2024/0327734 A1
(43) Pub. Date: Oct. 3, 2024

(54) BIOMASS GASIFICATION APPARATUS

(71) Applicant: Honda Motor Co., Ltd., Tokyo (JP)

(72) Inventors: Yusuke Oda, Wako-shi (JP); Kohtaro Hashimoto, Wako-shi (JP); Hiroshi Chishima, Wako-shi (JP)

(21) Appl. No.: 18/587,549

(22) Filed: Feb. 26, 2024

(30) Foreign Application Priority Data
Mar. 28, 2023 (JP) 2023-051007

(51) Int. Cl. C10J 3/50; C10J 3/48; C10J 3/72

(52) U.S. Cl. CPC C10J 3/503; C10J 3/482; C10J 3/723; C10J 2200/152; C10J 2200/158; C10J 2300/092; C10J 2300/0966; C10J 2300/0976

(57) ABSTRACT

Biomass gasification apparatus includes: gasification reaction furnace; upper supply unit configured to supply woody biomass and inert gas from above through feeding hole to furnace; lower supply unit configured to supply mixed gas containing inert gas from below to furnace; sensor configured to detect clogged state in which biomass is clogged in hole; and controller configured to control supply units to regulate upper supply flow rate of inert gas supplied by upper supply unit and lower supply flow rate of inert gas supplied by lower supply unit based on detection result by sensor. When clogged state is detected, controller increases upper supply flow rate to be higher than first flow rate and decreases lower supply flow rate to be lower than second flow rate so that sum of upper supply flow rate and lower supply flow rate is maintained at predetermined flow rate.

### CROSS-REFERENCE TO RELATED APPLICATION

This application is based upon and claims the benefit of priority from Japanese Patent Application No. 2023-051007 filed on Mar. 28, 2023, the content of which is incorporated herein by reference.

### BACKGROUND OF THE INVENTION

### Field of the Invention

The present invention relates to a biomass gasification apparatus configured to gasify biomass.

### Description of the Related Art

A device that continuously supplies biomass and that gasifies the biomass has been conventionally known. For example, in an apparatus described in JP 2009-235141 A), an observation window is provided at a feeding unit through which the biomass is fed into a gasification reactor, a clogged state of the feeding unit is detected by an optical sensor through the observation window. When the clogged state in which the biomass is clogged in the feeding unit is detected, high-pressure nitrogen gas is injected toward the feeding unit to remove the biomass clogged in the feeding unit.

However, in the apparatus described in JP 2009-235141 A, when the biomass is clogged, the nitrogen gas is injected into the reactor through the feeding unit. Hence, the temperature in the reactor temporarily decreases, thus the reaction temperature decreases, and it becomes difficult to perform a stable gasification reaction.

### SUMMARY OF THE INVENTION

An aspect of the present invention is a biomass gasification apparatus, including: a gasification reaction furnace; an upper supply unit configured to supply woody biomass and inert gas from above through a feeding hole to the gasification reaction furnace; a lower supply unit configured to supply mixed gas containing the inert gas from below to the gasification reaction furnace; a sensor configured to detect a clogged state in which the woody biomass is clogged in the feeding hole; and a controller configured to control the upper supply unit and the lower supply unit to regulate an upper supply flow rate of the inert gas supplied by the upper supply unit and a lower supply flow rate of the inert gas supplied by the lower supply unit based on a detection result by the sensor. When the clogged state is detected by the sensor, the controller increases the upper supply flow rate to be higher than a first flow rate and decreases the lower supply flow rate to be lower than a second flow rate so that a sum of the upper supply flow rate and the lower supply flow rate is maintained at a predetermined flow rate.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of a configuration in the periphery of a gasification reaction furnace of a biomass gasification apparatus according to an embodiment of the present invention;

FIG. 2 is an enlarged diagram in the vicinity of a feeding hole of FIG. 1;

FIG. 3 is a block diagram schematically illustrating an example of a control configuration of the biomass gasification apparatus according to the embodiment of the present invention;

FIG. 4 is a diagram for describing a fluidized state of fluid medium of FIG. 1;

FIG. 5 is a flowchart illustrating an example of flow rate control processing performed by a controller of FIG. 3;

FIG. 6 is an enlarged diagram in the vicinity of the feeding hole of a biomass gasification apparatus according to a modification;

FIG. 7 is a block diagram schematically illustrating an example of a control configuration of the biomass gasification apparatus of FIG. 6; and

FIG. 8 is a flowchart illustrating an example of flow rate control processing performed by a controller of FIG. 7.

### DETAILED DESCRIPTION OF THE INVENTION

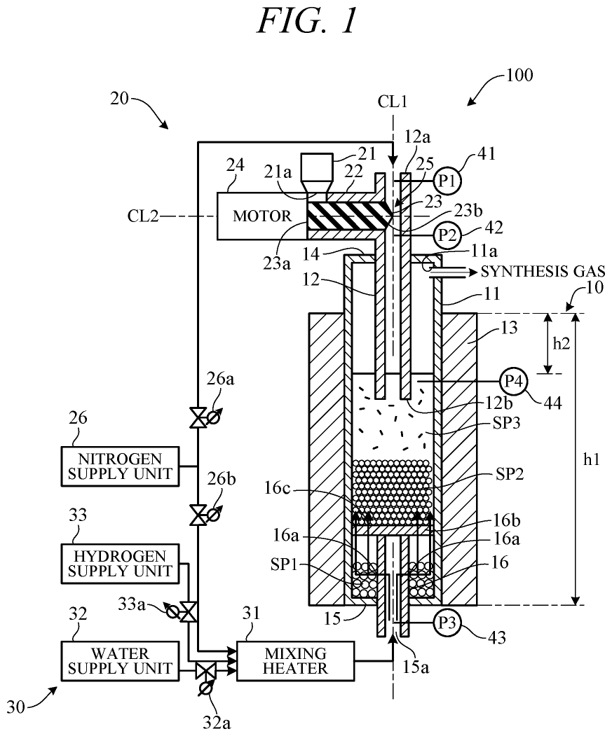

Hereinafter, embodiments of the present invention will be described with reference to FIGS. 1 to 8. A biomass gasification apparatus according to an embodiment of the present invention thermally decomposes woody biomass to produce a synthetic gas containing carbon monoxide, methane, and the like. The synthesis gas can be used as, for example, a fuel gas of a power generating gas engine.

The average global temperature is maintained in a warm state suitable for living organisms by greenhouse gases in the atmosphere. To be specific, heat radiated from the ground surface that has been heated by sunlight to outer space is partially absorbed by the greenhouse gases, and is re-radiated to the ground surface, and the atmosphere is maintained in a warm state. An increase in concentration of such greenhouse gases in the atmosphere causes a rise in the average global temperature (global warming).

Among the greenhouse gases, the concentration in the atmosphere of carbon dioxide that largely contributes to the global warming is decided by the balance between carbon fixed on the ground or in the ground as the biomass or fossil fuels and carbon present in the atmosphere as carbon dioxide. For example, the carbon dioxide in the atmosphere is absorbed through photosynthesis in the growth process of plants (biomass), and then the carbon dioxide concentration in the atmosphere decreases. The carbon dioxide is released into the atmosphere through consumption (combustion) of fossil fuels, and then the carbon dioxide concentration in the atmosphere increases. In order to suppress the global warming, there is a demand for replacing the fossil fuels with biomass-origin renewable fuels to reduce carbon emissions.

In gasifying woody biomass, chips of the woody biomass that has been pulverized beforehand are fed into a high-temperature gasification reaction furnace for dry distillation. In order to cause a desired chemical reaction to proceed in the gasification reaction furnace and to stably produce a synthesis gas having a desired composition, the temperature (the reaction temperature) in the gasification reaction furnace has to be maintained at appropriate temperatures. On the other hand, the woody biomass is thermally expanded under high-temperature conditions, and thus may be clogged in the feeding unit. Therefore, in the present embodiment, a biomass gasification apparatus is configured as follows so that clogging of the woody biomass can be eliminated, while the reaction temperature is maintained.

FIG. 1 is a diagram schematically illustrating an example of a configuration in the periphery of a gasification reaction furnace 10 of a biomass gasification apparatus (hereinafter, an apparatus) 100 according to an embodiment of the present invention. As illustrated in FIG. 1, the apparatus 100 includes: the gasification reaction furnace 10; an upper supply unit 20, which supplies woody biomass and nitrogen gas as an inert gas to the gasification reaction furnace 10 from above; and a lower supply unit 30, which supplies a mixed gas of steam, hydrogen gas, and nitrogen gas to the gasification reaction furnace 10 from below.

The gasification reaction furnace 10 includes: an outer pipe 11 and an inner pipe 12, which extend with an axis CL1 in a vertical direction as the center; and an electric furnace 13, which has a substantially cylindrical shape, and which is provided in close contact with an outer circumferential surface of the outer pipe 11. An upper end of the inner pipe 12 is positioned above an upper end of the outer pipe 11, and a lower end of the inner pipe 12 is positioned above a lower end of the outer pipe 11. The upper end of the outer pipe 11 is closed by an upper lid 14, which has an annular shape, and which connects an inner circumferential surface of the outer pipe 11 and an outer circumferential surface of the inner pipe 12. An upper end 12a of the inner pipe 12 is positioned above the upper lid 14. The lower end of the outer pipe 11 is closed by a lower lid 15, and an opening 15a is provided at a central part of the lower lid 15. A supply pipe 16, which is connected with the lower supply unit 30, is inserted into the opening 15a.

On the supply pipe 16, a plurality of hole portions 16a are provided in a range that faces the inner circumferential surface of the outer pipe 11. An upper end surface of the supply pipe 16 is closed by a plate 16b, which has a disk shape, and on which a plurality of hole portions 16c are radially provided. In a space SP1 having a cylindrical shape between the inner circumferential surface of the outer pipe 11 and the outer circumferential surface of the supply pipe 16, alumina beads each having a relatively large diameter are filled in a state in which a gap remains below the plate 16b. In a space SP2 inside the outer pipe 11 from the upper surface of the plate 16b to a predetermined height, alumina beads each having a relatively small diameter are filled. The mixed gas that has flowed into the space SP1 through the hole portion 16a of the supply pipe 16 flows through the gaps of the alumina beads filled in the space SP1, flows into the space SP2 through the hole portions 16c of the plate 16b, and flows through the gaps of the alumina beads filled in the space SP2. The alumina beads are filled in the spaces SP1 and SP2, so that the temperatures of the spaces SP1 and SP2 can be easily maintained, and the flow of the mixed gas passing through the space SP2 can be adjusted.

In the space SP3 inside the outer pipe 11 from an upper surface of the layer of the alumina beads filled in the space SP2 to a lower surface of the upper lid 14, a fluid medium such as silica sand is filled up to a predetermined height. A lower end 12b of the inner pipe 12 is positioned inside a layer (a filled layer) of the fluid medium filled in the space SP3. Chips of the woody biomass are supplied to the space SP3 from above. The fluid medium and the chips in the space SP3 are fluidized by being blown up by the mixed gas supplied from below, and behave like a liquid. The fluidized layer of the fluid medium (a fluidized bed) serves as a reaction field of gasification reaction. In the fluidized bed having a uniform temperature distribution, the mixed gas and the chips of the woody biomass are sufficiently and uniformly brought into contact with each other, and the temperature distribution becomes uniform, so that the reaction rate of the gasification reaction can be increased.

The electric furnace 13 is provided to surround from the lower end of the outer pipe 11 to a predetermined height h1. The predetermined height h1 is set in consideration of a height h2 in which the fluid medium in the space SP3 is blown up. Therefore, the inside of the gasification reaction furnace 10 has a steam atmosphere of the mixed gas supplied from below, and the fluidized bed in the space SP3, which is surrounded by the electric furnace 13, is maintained at a predetermined reaction temperature. When chips of the woody biomass are supplied from above to such a fluidized bed through a feeding hole 25, a gasification reaction (a thermal decomposition reaction) of the biomass proceeds in the fluidized bed, and a synthesis gas is generated.

The outer pipe 11 is provided with a discharge port 11a above the electric furnace 13. The synthesis gas that has been generated in the fluidized bed is discharged from the gasification reaction furnace 10 through the space SP3 and the discharge port 11a on the upper side of the fluidized bed. The synthesis gas that has been discharged from the gasification reaction furnace 10 is used, after moisture, tar components, and the like are removed through a gas-liquid separator, a condenser, and the like, not illustrated.

The upper supply unit 20 includes: a hopper 21, which stores the chips; a supply pipe 22, which extends with a horizontal axis CL2 as the center, and which connects a discharge port 21a of the hopper 21 with the inner pipe 12 of the gasification reaction furnace 10; and a screw 23, which is disposed inside the supply pipe 22. One end 23a of the screw 23 is connected with a motor 24, and the other end 23b of the screw 23 is positioned inside the inner pipe 12 of the gasification reaction furnace 10. The screw 23 is driven by the motor 24, rotates about the axis CL2, and conveys the chips that has been dropped from the hopper 21 through the discharge port 21a into the inner pipe 12. A space inside the supply pipe 22 that faces the other end 23b of the screw 23 will be hereinafter referred to as the feeding hole 25.

The upper supply unit 20 further includes a nitrogen supply unit 26, which is connected with the upper end 12a of the inner pipe 12, and which supplies the nitrogen gas into the gasification reaction furnace 10 from above through the inner pipe 12. The nitrogen supply unit 26 is configured as a high-pressure tank filled with the nitrogen gas, and piping that connects the nitrogen supply unit 26 with the upper end 12a of the inner pipe 12 is provided with a regulating valve 26a, which regulates a flow rate Un1 of the nitrogen gas supplied from above into the gasification reaction furnace 10.

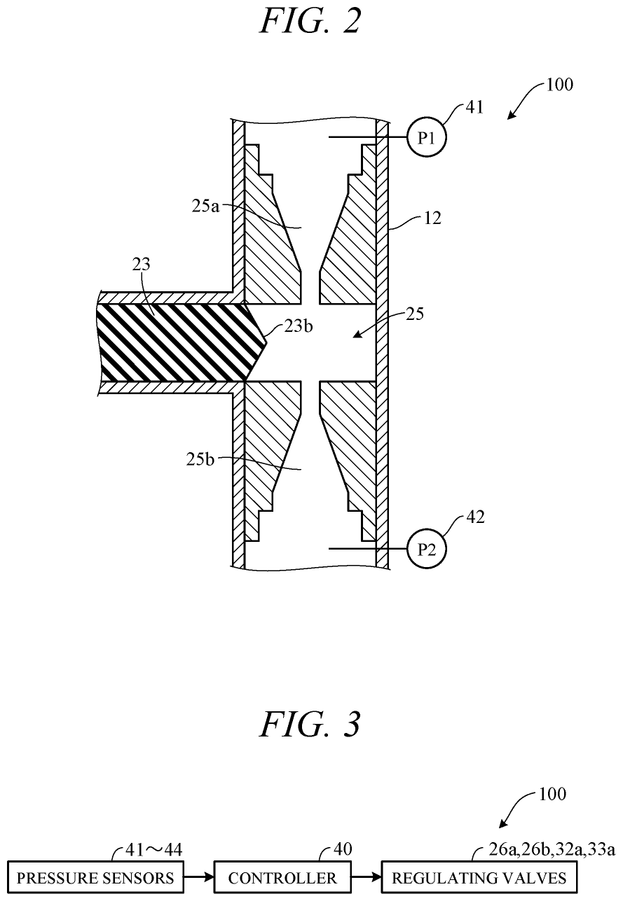

FIG. 2 is an enlarged diagram in the vicinity of the feeding hole 25. As illustrated in FIG. 2, a nozzle portion 25a is provided on an inlet side of the feeding hole 25, a diffuser portion 25b is provided on an outlet side of the feeding hole 25, and the feeding hole 25 is formed as a venturi portion in which the inner diameter of the inner pipe 12 is narrowed. The flow velocity of the nitrogen gas that has been supplied from above by the nitrogen supply unit 26 is increased by passing through the nozzle portion 25a, and the chips that have been supplied by the screw 23 from a lateral side to the feeding hole 25 can be injected downward through the diffuser portion 25b. In addition, as the flow velocity of the nitrogen gas increases, the feeding hole 25 has a negative pressure, and is capable of sucking the chips that have been conveyed by the screw 23. This enables the chips of the woody biomass that are easily fuzzed to be supplied together with the nitrogen gas from above to the gasification reaction furnace 10 through the feeding hole 25.

The lower supply unit 30 includes: a mixing heater 31, which is connected with a lower end of the supply pipe 16; a water supply unit 32, which supplies water to the mixing heater 31; a hydrogen supply unit 33, which supplies hydrogen gas to the mixing heater 31; and the nitrogen supply unit 26, which supplies nitrogen gas to the mixing heater 31. The water supply unit 32 is configured as a water supply pump that pumps up water from a water source, not illustrated, and that supplies the water to the mixing heater 31, and piping that connects the water supply unit 32 with the mixing heater 31 is provided with a regulating valve 32a, which regulates a flow rate Us of the water. The hydrogen supply unit 33 is configured as a high-pressure tank filled with hydrogen gas, and piping that connects the hydrogen supply unit 33 with the mixing heater 31 is provided with a regulating valve 33a, which regulates a flow rate Uh of the hydrogen gas. Piping that connects the nitrogen supply unit 26 with the mixing heater 31 is provided with a regulating valve 26b, which regulates a flow rate Un2 of the nitrogen gas supplied from below into the gasification reaction furnace 10.

In the mixing heater 31, the water that has been supplied from the water supply unit 32 is heated and vaporized, and steam is generated. The steam is mixed with the hydrogen gas that has been supplied from the hydrogen supply unit 33 and the nitrogen gas that has been supplied from the nitrogen supply unit 26, and a high-temperature mixed gas is generated. The high-temperature mixed gas that has been generated in the mixing heater 31 is supplied into the gasification reaction furnace 10 from below through the supply pipe 16.

FIG. 3 is a block diagram schematically illustrating an example of a control configuration of the apparatus 100. As illustrated in FIG. 3, the apparatus 100 further includes a controller 40, which controls the regulating valves 26a, 26b, 32a, and 33a. In addition, as illustrated in FIGS. 2 and 3, provided are a pressure sensor 41, which detects a pressure P1 on an inlet side of the feeding hole 25 (an upstream side of the nozzle portion 25a); a pressure sensor 42, which detects a pressure P2 on an outlet side of the feeding hole 25 (a downstream side of the diffuser portion 25b); a pressure sensor 43, which detects a pressure P3 on a lower side (an inlet side) of the filled layer of the fluid medium, for example, in the supply pipe 16; and a pressure sensor 44, which detects a pressure P4 on an upper side (an outlet side) of the filled layer, for example, in an upper part of the filled layer.

As illustrated in FIG. 2, in a normal state in which the tip is not clogged in the feeding hole 25, the pressure P1 on the inlet side and the pressure P2 on the outlet side of the feeding hole 25 is equal to each other (P1=P2). On the other hand, in a clogged state in which the tip is clogged in the feeding hole 25, the pressure P1 on the inlet side of the feeding hole 25 is lower than the pressure P2 on the outlet side, because a pressure loss occurs (P1<P2). The pressure sensors 41 and 42 will be referred to as state detection sensors that detect a clogged state of the feeding hole 25, in some cases.

The controller 40 includes a computer including a CPU, a RAM, a ROM, an I/O interface, and other peripheral circuits, and the CPU functions as a flow rate control unit that controls the upper supply unit 20 (the regulating valve 26a) and the lower supply unit 30 (the regulating valves 26b, 32a, and 33a). Whether the feeding hole 25 is in the normal state or the clogged state is determined, based on the pressures P1 and P2, which have been respectively detected by the pressure sensors 41 and 42. When determining that the feeding hole 25 is in the normal state, the controller 40 controls the regulating valves 26a, 26b, 32a, and 33a so that a flow rate Un (Un=Un1+Un2) of the nitrogen gas, the flow rate Us of the water (the steam), and the flow rate Uh of the hydrogen gas supplied into the gasification reaction furnace 10 respectively become prescribed flow rates Un0, Us0, and Uh0.

The prescribed flow rate Us0 of the water (the steam) is defined so that a weight ratio S/B of steam (S: Steam) to biomass (B: Biomass) becomes a predetermined value (for example, approximately 0.5) in accordance with a supplied amount of the woody biomass per unit time (for example, approximately 100 [g/h]). The prescribed flow rate Un0 of the nitrogen gas is defined so that the ratio between the steam and the nitrogen gas becomes a predetermined value (for example, approximately 40:60) in accordance with the prescribed flow rate Us0 of the water (the steam). Similarly, the prescribed flow rate Uh0 of the hydrogen gas is defined so that the ratio between steam and the hydrogen gas becomes a predetermined value in accordance with the prescribed flow rate Us0 of the water (the steam). This enables a desired chemical reaction to proceed in the gasification reaction furnace, and enables production of a synthesis gas having a desired composition.

A prescribed flow rate Un10 of the nitrogen gas supplied from above is defined as a value (αUn0) obtained by multiplying the prescribed flow rate Un0 of the nitrogen gas by a predetermined value α (0<α<1). A prescribed flow rate Un20 of the nitrogen gas supplied from below is defined as a value ((1−α) Un0) obtained by multiplying the prescribed flow rate Un0 of the nitrogen gas by a predetermined value (1−α).

When determining that the feeding hole 25 is in the clogged state, the controller 40 controls the regulating valves 26a and 26b to increase the flow rate Un1 of the nitrogen gas supplied from above and decrease the flow rate Un2 of the nitrogen gas supplied from below so that the flow rate Un of the nitrogen gas supplied into the gasification reaction furnace 10 is maintained at the prescribed flow rate Un0. That is, the flow rate Un1 of the nitrogen gas supplied from above is increased to a value (Un10+ΔUn) obtained by adding a predetermined flow rate ΔUn to the prescribed flow rate Un10, and the flow rate Un2 of the nitrogen gas supplied from below is decreased to a value (Un20−ΔUn) obtained by subtracting the predetermined flow rate ΔUn from the prescribed flow rate Un20.

By increasing the flow rate Un1 of the nitrogen gas supplied from above, the flow velocity of the nitrogen gas in the feeding hole 25 is increased, and the chips are blown downward, so that clogging of the feeding hole 25 can be eliminated. In this case, the reaction condition such as the weight ratio S/B of the steam to the biomass is maintained. Therefore, the reaction rate of a desired chemical reaction is not reduced, and the yield of the synthesis gas having a desired composition is not reduced. In addition, by decreasing the flow rate Un2 of the nitrogen gas supplied from below in accordance with an increase in the flow rate Un1 of the nitrogen gas supplied from above, the total amount of the nitrogen gas supplied into the gasification reaction furnace 10 is maintained at a constant amount. In this case, the heat capacity and the reaction temperature in the gasification reaction furnace 10 are maintained. Therefore, the reaction rate of a desired chemical reaction is not reduced, and the yield of the synthesis gas having a desired composition is not reduced.

The predetermined flow rate ΔUn, which is added to or subtracted from the prescribed flow rate Un10 or Un20, can be gradually increased, until the state detection sensor no longer detects the clogged state. However, a condition is set such that a flow velocity Uc of the mixed gas falls within a flow rate range in which the fluidized bed in the gasification reaction furnace 10 can be maintained.

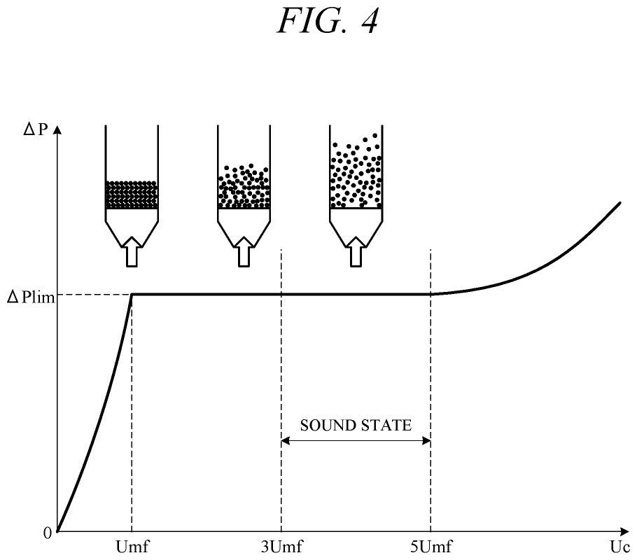

FIG. 4 is a diagram for describing a fluidized state of the fluid medium. In FIG. 4, the horizontal axis represents the flow velocity Uc of the mixed gas supplied into the gasification reaction furnace 10 from below by the lower supply unit 30, and the vertical axis represents a pressure difference ΔP between the pressure P3 on the lower side (the inlet side) and the pressure P4 on the upper side (the outlet side) of the filled layer of the fluid medium. It is possible to calculate the flow rate [m3/sec] of the mixed gas supplied into the gasification reaction furnace 10 from below, based on the flow rate Un2 of the nitrogen gas supplied from below, the flow rate Us of the water (the steam), the flow rate Uh of the hydrogen gas, the temperature of the mixed gas, and the like. The flow velocity Uc [m/sec] of the mixed gas denotes an average flow velocity when the mixed gas flows into the filled layer of the fluid medium, and can be calculated by dividing the flow rate [m3/sec] of the mixed gas by a cross-sectional area of the outer pipe 11 (the space SP3).

As illustrated in FIG. 1, the mixed gas supplied into the gasification reaction furnace 10 from below is subject to flow adjustment in the space SP2, and flows into the filled layer of the space SP3. As illustrated in FIG. 4, when the flow velocity Uc at the time of flowing into the filled layer is low, the mixed gas flows through gaps in the fluid medium, the fluid medium maintains a stationary state, and fluidization of the fluid medium does not occur (a fixed layer). When the flow velocity Uc increases, the pressure in the gap in the fluid medium through which the mixed gas flows gradually decreases, and a pressure drop (a pressure loss) in the filled layer, that is, the pressure difference ΔP between the inlet side and the outlet side of the filled layer increases. When such a pressure drop (the pressure difference ΔP) exceeds the weight of the filled layer (the fluid medium), the fluidization of the fluid medium starts (the fluidized bed). The fluidization starts, and then the pressure difference ΔP becomes constant. The pressure drop (the pressure difference ΔP) at the time when the fluidization starts will be referred to as a fluidization pressure drop Plim, and the flow velocity Uc at the time when the fluidization starts will be referred to as a minimum fluidization velocity Umf.

By maintaining the flow velocity Uc of the mixed gas at approximately three to five times the minimum fluidization velocity Umf, the fluidized bed in a sound state can be maintained. The prescribed flow rate Un20 of the nitrogen gas supplied from below is defined so that the flow velocity Uc of the mixed gas is, for example, approximately five times the minimum fluidization velocity Umf. By setting the prescribed flow rate Un20 of the nitrogen gas supplied from below to near an upper limit of the range in which the fluidized bed in a sound state can be maintained, it is possible to ensure a sufficient margin when the flow rate Un2 of the nitrogen gas supplied from below is decreased in accordance with a clogged state of the feeding hole 25.

The controller 40 calculates the pressure difference ΔP in the filled layer of the fluid medium, based on the pressures P3 and P4, which have been respectively detected by the pressure sensors 43 and 44, and determines whether the calculated pressure difference ΔP is equal to or larger than the fluidization pressure drop Plim. In a case where it is determined that the pressure difference ΔP is smaller than the fluidization pressure drop Plim and the fluidized bed cannot be maintained, the regulating valves 26a and 26b are controlled to return the flow rate Un1 of the nitrogen gas supplied from above to the prescribed flow rate Un10 and the flow rate Un2 supplied from below to the prescribed flow rate Un20. Accordingly, the lower supply unit 30 (the regulating valve 26b) is controlled so that the flow velocity Uc of the mixed gas is always equal to or higher than the minimum fluidization velocity Umf, so that the fluidized bed can be maintained. Note that when the flow velocity Uc of the mixed gas is adjusted, the pressure difference ΔP is changed by mainly changing the pressure P3 on the inlet side of the filled bed. The pressure P4 on the outlet side of the filled layer is usually maintained at a pressure in the gasification reaction furnace 10 that is almost equal to the atmospheric pressure.

In a case where the controller 40 determines that the fluidized bed cannot be maintained, based on the pressures P3 and P4, returns the flow rates of the nitrogen gas to the prescribed flow rates Un10 and Un20, and then determines that the feeding hole 25 is in the clogged state, the controller 40 controls the regulating valve 32a to decrease the flow rate Us of the water (the steam). That is, in a case where it is not possible to eliminate the clogged state of the feeding hole 25, the flow rate Us of the steam is decreased in accordance with a decrease in supply amount of the biomass so as to maintain the reaction condition of the weight ratio S/B of the steam to the biomass. As a result, although the yield of the synthesis gas is reduced, the operation of the apparatus 100 can be continued, while the reaction rate of a desired chemical reaction and the yield of the synthesis gas having a desired composition are maintained.

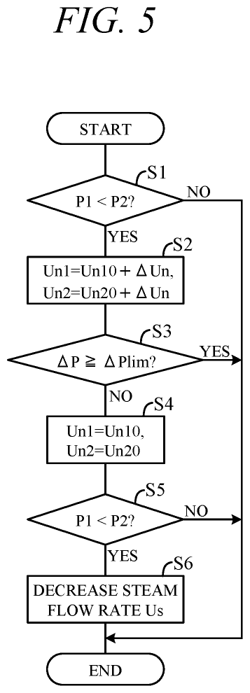

FIG. 5 is a flowchart illustrating an example of flow rate control processing performed by the controller 40. The processing illustrated in this flowchart is repeatedly performed at a predetermined cycle. As illustrated in FIG. 5, first, in step S1, whether the pressure P1, which has been detected by the pressure sensor 41, is lower than the pressure P2, which has been detected by the pressure sensor 42, is determined. In a case where a negative determination is made in step S1, it is determined that the feeding hole 25 is in the normal state, and the processing ends. In a case where an affirmative determination is made in step S1, it is determined that the feeding hole 25 is in the clogged state, and the processing proceeds to step S2. In step S2, the regulating valves 26a and 26b are controlled so that the flow rate Un1 of the nitrogen gas supplied from above is increased by the predetermined flow rate ΔUn, and the flow rate Un2 of the nitrogen gas supplied from below is decreased by the predetermined flow rate ΔUn.

Next, in step S3, the pressure difference ΔP in the filled layer of the fluid medium is calculated, based on the pressures P3 and P4, which have been respectively detected by the pressure sensors 43 and 44, and it is determined whether the calculated pressure difference ΔP is equal to or larger than the fluidization pressure drop Plim. In a case where an affirmative determination is made in step S3, it is determined that the fluidized bed can be maintained, and the processing ends. In a case where a negative determination is made in step S3, it is determined that the fluidized bed cannot be maintained, the processing proceeds to step S4, and the regulating valves 26a and 26b are respectively controlled to return the flow rate Un1 of the nitrogen gas supplied from above and the flow rate Un2 of the nitrogen gas supplied from below to the prescribed flow rates Un10 and Un20.

Next, in step S5, it is determined whether the pressure P1, which has been detected by the pressure sensor 41, is lower than the pressure P2, which has been detected by the pressure sensor 42. In a case where a negative determination is made in step S5, it is determined that the feeding hole 25 is in the normal state, and the processing ends. In a case where an affirmative determination is made in step S5, it is determined that the clogged state of the feeding hole 25 continues, the processing proceeds to step S6, the regulating valve 32a is controlled to decrease the flow rate Us of the water (the steam), and the processing ends.

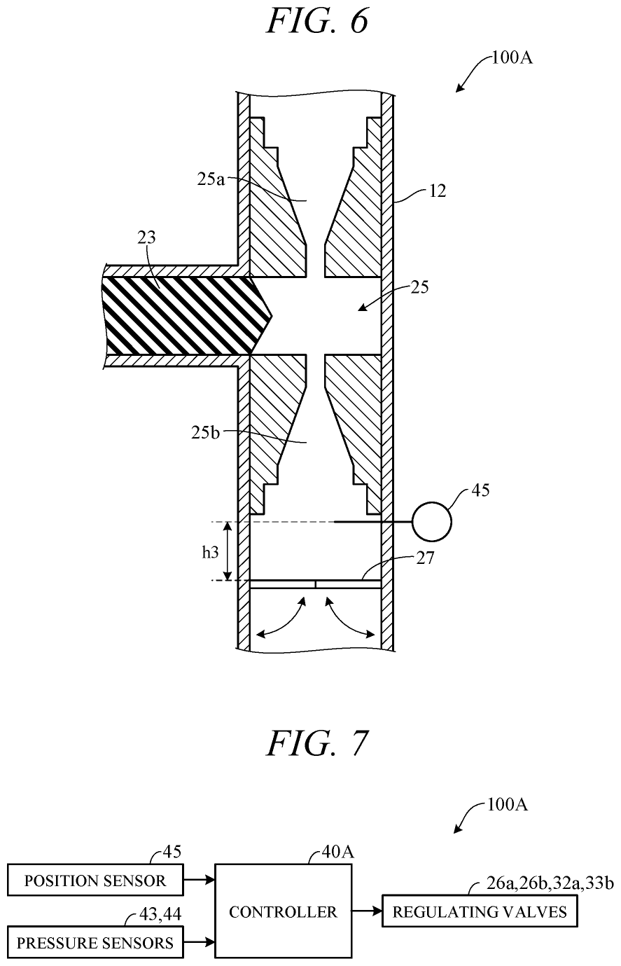

FIG. 6 is an enlarged diagram in the vicinity of the feeding hole 25 of a biomass gasification apparatus (hereinafter, an apparatus) 100A according to a modification. In the apparatus 100A, an opening and closing portion 27 is provided below the feeding hole 25 (the diffuser portion 25b). In addition, in place of the pressure sensors 41 and 42, a position sensor 45 is provided on an inner wall surface of the inner pipe 12 between the feeding hole 25 (the diffuser portion 25b) and the opening and closing portion 27. The position sensor 45 is provided above an upper surface of the opening and closing portion 27 by a predetermined height h3. The predetermined height h3 is set in consideration of the height of the chips deposited on the opening and closing portion 27 every predetermined time (for example, one minute) in accordance with the supply amount of the woody biomass (for example, approximately 100 [g/h]) per unit time.

The position sensor 45 is configured as, for example, a contact sensor. When the chips deposited on the opening and closing portion 27 reach the predetermined height h3, the position sensor 45 contacts the chips, detects that the chips are deposited up to the predetermined height h3, and transmits a signal to the opening and closing portion 27. The opening and closing portion 27 is usually closed, but is opened and closed (opened and then closed) in accordance with the signal from the position sensor 45, and drops the chips deposited on the upper surface downward at every predetermined time. In the normal state in which the chip is not clogged in the feeding hole 25, the position sensor 45 detects deposition of the chips at every predetermined time. However, in the clogged state in which the chip is clogged in the feeding hole 25, the deposition of the chips is not detected at every predetermined time. The position sensor 45 will be referred to as a state detection sensor that detects the clogged state of the feeding hole 25, in some cases.

FIG. 7 is a block diagram schematically illustrating an example of a control configuration of the apparatus 100A. As illustrated in FIG. 7, the position sensor 45 is connected with a controller 40A of the apparatus 100A, in place of the pressure sensors 41 and 42. The controller 40A monitors a signal transmitted from the position sensor 45 to the opening and closing portion 27, and determines whether the feeding hole 25 is in the normal state or in the clogged state.

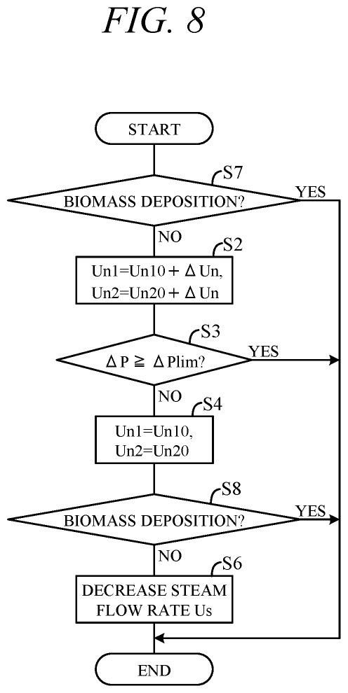

FIG. 8 is a flowchart illustrating an example of flow rate control processing performed by the controller 40A. The processing illustrated in this flowchart is repeatedly performed at every predetermined time. As illustrated in FIG. 8, first, in step S7, it is determined whether the position sensor 45 detects the deposition of the chips at every predetermined time. In a case where an affirmative determination is made in step S7, it is determined that the feeding hole 25 is in the normal state, and the processing ends. In a case where a negative determination is made in step S7, it is determined that the feeding hole 25 is in the clogged state, and the processing proceeds to step S2. The processing in steps S2 to S4 is similar to that in FIG. 5.

In step S4, when the flow rate Un1 of the nitrogen gas supplied from above and the flow rate Un2 of the nitrogen gas supplied from below are respectively returned to the prescribed flow rates Un10 and Un20, the processing proceeds to step S8, and it is determined whether the position sensor 45 detects the deposition of the chips at every predetermined time. In a case where an affirmative determination is made in step S8, it is determined that the feeding hole 25 is in the normal state, and the processing ends. In a case where a negative determination is made in step S8, it is determined that the clogged state of the feeding hole 25 continues, the processing proceeds to step S6, and the regulating valve 32a is controlled to decrease the flow rate Us of the water (the steam), and the processing ends.

According to the present embodiment, the following operations and effects are achievable.

(1) The apparatus 100 includes: the gasification reaction furnace 10; the upper supply unit 20 that supplies the woody biomass and the nitrogen gas from above through the feeding hole 25 to the gasification reaction furnace 10; the lower supply unit 30 that supplies a mixed gas containing the nitrogen gas from below to the gasification reaction furnace 10; the state detection sensor (the pressure sensors 41 and 42, the position sensor 45) that detects a clogged state in which the woody biomass is clogged in the feeding hole 25; and the controller 40 that controls the upper supply unit 20 (the regulating valve 26a) and the lower supply unit 30 (the regulating valves 26b, 32a, and 33a) to regulate the supply flow rate Un1 of the nitrogen gas supplied by the upper supply unit 20 and the supply flow rate Un2 of the nitrogen gas supplied by the lower supply unit 30, based on a detection result by the state detection sensor (FIGS. 1, 3, 6, and 7).

When the clogged state is detected by the state detection sensor, the controller 40 increases the supply flow rate Un1 of the nitrogen gas supplied by the upper supply unit 20 to be higher than the prescribed flow rate Un10, and decreases the supply flow rate Un2 of the nitrogen gas supplied by the lower supply unit 30 to be lower than the prescribed flow rate Un20 so that the sum of the supply flow rate Un1 of the nitrogen gas supplied by the upper supply unit 20 and the supply flow rate Un2 of the nitrogen gas supplied by the lower supply unit 30 (Un1+Un2) (that is, the flow rate Un of the nitrogen gas supplied into the gasification reaction furnace 10) is maintained at the prescribed flow rate Un0 (steps S1 and S2 in FIG. 5, steps S6 and S2 in FIG. 8).

By increasing the supply flow rate Un1 of the nitrogen gas supplied by the upper supply unit 20, the flow velocity in the feeding hole 25 is increased, and the chip clogged in the feeding hole 25 is injected downward, so that the clogged state can be eliminated. By detecting and eliminating the clogged state and keeping the supply amount of the woody biomass constant, the balance between the biomass and the reaction gas such as steam contained in the mixed gas in the gasification reaction furnace 10 is maintained, so that the reaction rate of a desired chemical reaction and the yield of the synthesis gas having a desired composition can be maintained. In addition, by keeping the total amount of the nitrogen gas supplied into the gasification reaction furnace 10 constant, the heat capacity and the reaction temperature in the gasification reaction furnace 10 is maintained, so that the reaction rate of a desired chemical reaction and the yield of the synthesis gas having a desired composition can be maintained.

(2) The apparatus 100 further includes the fluid medium filled in the gasification reaction furnace 10 (FIG. 1). The controller 40 controls the lower supply unit 30 so that the flow velocity Uc of the mixed gas supplied by the lower supply unit 30 is equal to or higher than the minimum fluidization velocity Umf of the fluid medium in the gasification reaction furnace 10 (FIG. 4). This maintains a fluidized bed to be a reaction field of the gasification reaction, so that a high reaction rate of the gasification reaction can be maintained.

(3) The apparatus 100 further includes the pressure sensors 43 and 44, which respectively detect the pressure P3 on the lower side and the pressure P4 on the upper side of the fluid medium filled in the gasification reaction furnace 10 (FIG. 1). The controller 40 determines whether the fluid medium is in a predetermined fluidized state, based on the pressure difference ΔP between the pressure P3 on the lower side and the pressure P4 on the upper side of the fluid medium. In a case of determining that the fluid medium is not in the predetermined fluidized state, the controller 40 returns the supply flow rate Un1 of the nitrogen gas supplied by the upper supply unit 20 to the prescribed flow rate Un10, and returns the supply flow rate Un2 of the nitrogen gas supplied by the lower supply unit 30 to the prescribed flow rate Un20 (steps S3 and S4 in FIGS. 5 and 8). This enables the fluidized bed to be maintained all the time.

(4) The mixed gas further contains steam. In a case where the controller 40 determines that the fluid medium is not in the predetermined fluidized state and the state detection sensor detects the clogged state, the controller 40 decreases the supply flow rate Us of the steam by the lower supply unit 30 (steps S3 to S6 in FIG. 5, steps S3, S4, S7, and S6 in FIG. 8). In this manner, even in a case where it is not possible to eliminate the clogged state, the fluidized bed is maintained, and the reaction condition such as the weight ratio S/B between the steam and the biomass is maintained, so that the operation of the apparatus 100 can be continued, while the reaction rate of a desired chemical reaction and the yield of the synthesis gas having a desired composition are maintained.

In the above embodiment, an example of using chips of the woody biomass has been described. However, the woody biomass is not limited to the chips, and may be pellets, powder (wood flour), or the like. In the above embodiment, an example in which the nitrogen gas is used as the inert gas has been described. However, the inert gas is not limited to the nitrogen gas, and any gas may be used as long as it does not affect the gasification reaction in the biomass gasification apparatus. In the above embodiment, specific configurations of the upper supply unit and the lower supply unit have been exemplified and described. However, the upper supply unit and the lower supply unit are not limited to those that have been exemplified. For example, different supply sources (high-pressure tanks or the like) of the inert gas may be used for the upper supply unit and the lower supply unit. In the above embodiment, an example in which woody biomass, steam, and hydrogen are used as reactants has been described. However, the biomass gasification apparatus may use another reaction gas as long as it supplies the woody biomass and the inert gas from above and a mixed gas containing the inert gas from below. In the above embodiment, an example in which the pressure sensor or the position sensor is used as the sensor that detects the clogged state in which the woody biomass is clogged in the feeding hole has been described. However, any sensor may be applicable, as long as it detects the clogged state of the feeding hole. For example, an image sensor or a weight sensor may detect the clogged state or the deposited state of the woody biomass. In the above embodiment, the specific arrangement examples of the pressure sensors 43 and 44 have been described. However, pressure detection units that respectively detect the pressure on the lower side and the pressure on the upper side of the fluid medium are not limited to those illustrated.

The above embodiment can be combined as desired with one or more of the aforesaid modifications. The modifications can also be combined with one another.

According to the present invention, it becomes possible to eliminate clogging of the woody biomass while maintaining the reaction temperature.

Above, while the present invention has been described with reference to the preferred embodiments thereof, it will be understood, by those skilled in the art, that various changes and modifications may be made thereto without departing from the scope of the appended claims.

1. A biomass gasification apparatus, comprising:
a gasification reaction furnace;
an upper supply unit configured to supply woody biomass and inert gas from above through a feeding hole to the gasification reaction furnace;
a lower supply unit configured to supply mixed gas containing the inert gas from below to the gasification reaction furnace;
a sensor configured to detect a clogged state in which the woody biomass is clogged in the feeding hole; and
a controller configured to control the upper supply unit and the lower supply unit to regulate an upper flow rate of the inert gas supplied by the upper supply unit and a lower flow rate of the inert gas supplied by the lower supply unit based on a detection result by the sensor, wherein
when the clogged state is detected by the sensor, the controller increases the upper flow rate to be higher than a first flow rate and decreases the lower flow rate to be lower than a second flow rate so that a sum of the upper flow rate and the lower flow rate is maintained at a predetermined flow rate.

2. The biomass gasification apparatus according to claim 1, further comprising:
a fluid medium filled in the gasification reaction furnace, wherein
the controller controls the lower supply unit so that a flow velocity of the mixed gas supplied by the lower supply unit is equal to or higher than a minimum fluidization velocity of the fluid medium in the gasification reaction furnace.

3. The biomass gasification apparatus according to claim 2, further comprising:
a pressure sensor configured to detect a lower pressure on a lower side the fluid medium filled in the gasification reaction furnace and an upper pressure on an upper side of the fluid medium filled in the gasification reaction furnace, wherein
the controller:
determines whether the fluid medium is in a predetermined fluidized state based on a difference between the lower pressure and the upper pressure; and
returns the upper flow rate to the first flow rate and returns the lower flow rate to the second flow rate when it is determined that the fluid medium is not in the predetermined fluidized state.

4. The biomass gasification apparatus according to claim 3, wherein
the mixed gas further contains steam, wherein
the controller decreases a flow rate of the steam supplied by the lower supply unit when it is determined that the fluid medium is not in the predetermined fluidized state and the clogged state is detected by the sensor.

5. The biomass gasification apparatus according to claim 1, wherein
the woody biomass is in one of chip form, pellet form, and powder form.

6. The biomass gasification apparatus according to claim 1, wherein
the upper supply unit includes:
a hopper storing the woody biomass;
a supply pipe extending horizontally and connecting the hopper and the gasification reaction furnace; and
a screw disposed inside the supply pipe, wherein
the screw is driven by a motor to convey the woody biomass from the hopper into the gasification reaction furnace.

7. The biomass gasification apparatus according to claim 6, wherein
an inlet of the gasification reaction furnace to which the supply pipe is connected is formed in a venturi shape.
